(19) United States
(12) Patent Application Publication
(10) Pub. No.: US 2025/0234219 A1
(43) Pub. Date: Jul. 17, 2025

(54) NETWORK ASSISTED USER EQUIPMENT MACHINE LEARNING MODEL HANDLING

(71) Applicant: TELEFONAKTIEBOLAGET LM ERICSSON (PUBL), STOCKHOLM (SE)

(72) Inventors: Henrik Rydén, Stockholm (SE); Adrian Garcia Rodriguez, Massy (FR); Daniel Chen Larsson, Lund (SE); Jingya Li, Göteborg (SE)

(21) Appl. No.: 18/853,055

(22) PCT Filed: Mar. 29, 2023
(86) PCT No.: PCT/IB2023/053133

§ 371 Date: Sep. 30, 2024

Related U.S. Application Data
(60) Provisional application No. 63/325,036, filed on Mar. 29, 2022.
(60) Provisional application No. 63/324,917, filed on Mar. 29, 2022.

(51) Int. Cl. H04W 24/04; H04W 24/08

(52) U.S. Cl. CPC H04W 24/04; H04W 24/08

(57) ABSTRACT

A method performed by a user equipment (UE) is provided. The method comprises sending, in response to a request from a network node, information associated with one or more machine-learning (ML) models operable by the UE; and receiving, from a network node, a representation of at least one modification of one or more variables associated with at least one ML model of the one or more ML models. The one or more variables are based on the information associated with the one or more ML models, and the at least one modification of the one or more variables facilitates at least partially correcting or preventing performance degradations of the at least one ML model.

### CROSS REFERENCE TO RELATED APPLICATION

This application claims priority to U.S. Provisional Patent Application No. 63/325,036 filed on Mar. 29, 2022, titled “NETWORK ASSISTED UE ML MODEL HANDLING,” and U.S. Provisional Patent Application No. 63/324,917 filed on Mar. 29, 2022, titled “NETWORK ASSISTED ERROR DETECTION FOR ARTIFICIAL INTELLIGENCE ON AIR INTERFACE.” The contents of both applications are hereby incorporated by reference in its entirety for all purposes.

### FIELD

The present disclosure relates generally to communication systems and, more specifically, to methods and systems for improving machine learning (ML) model performance by detecting ML model performance degradations and analyzing causes for the degradations.

### BACKGROUND

Artificial intelligence (AI) and machine learning (ML) technologies are being developed as tools to enhance the design of air-interfaces in wireless communication networks. Example use cases of AI and ML technologies include using autoencoders for channel state information (CSI) compression to reduce the feedback overhead and improve channel prediction accuracy; using deep neural networks for classifying line of sight (LOS) and non-LOS (NLOS) conditions to enhance the positioning accuracy; using reinforcement learning for beam selection at the network node side and/or the UE side to reduce the signaling overhead and beam alignment latency; and using deep reinforcement learning to learn an optimal precoding policy for complex multiple input multiple output (MIMO) precoding problems.

In 3GPP new radio (NR) technology development, the benefits of augmenting the air-interface with features enabling improved support of AI/ML based algorithms for enhanced performance and/or reduced complexity/overhead have been, and are still being, explored. By analyzing a few selected use cases (e.g., CSI feedback, beam management and positioning, etc.), the technology development work aims at laying the foundation for future air-interface use cases leveraging AI/ML techniques.

### SUMMARY

Various computer-implemented systems, methods, and articles of manufacture for detecting ML model performance degradation and analyzing causes for the degradation are described herein.

In one embodiment, a method performed by a user equipment (UE) is provided. The method comprises sending, in response to a request from a network node, information associated with one or more machine-learning (ML) models operable by the UE; and receiving, from a network node, a representation of at least one modification of one or more variables associated with at least one ML model of the one or more ML models. The one or more variables are based on the information associated with the one or more ML models, and the at least one modification of the one or more variables facilitates at least partially correcting or preventing performance degradations of the at least one ML model.

In one embodiment, a method performed by a network node is provided. The method comprises requesting a user equipment (UE) to report information associated with one or more machine-learning (ML) models operable by the UE; receiving, from the UE, the information associated with the one or more ML models operable by the UE; and sending, to the UE, a representation of at least one modification of one or more variables associated with at least one ML model of the one or more ML models. The one or more variables are based on the information associated with the one or more ML models, and the at least one modification of the one or more variables facilitates at least partially correcting or preventing the performance degradations of the at least one ML model.

In one embodiment, a UE is provided. The UE comprises a transceiver, a processor, and a memory, said memory containing instructions executable by the processor whereby the UE is operative to perform a method. The method comprises sending, in response to a request from a network node, information associated with one or more machine-learning (ML) models operable by the UE; and receiving, from a network node, a representation of at least one modification of one or more variables associated with at least one ML model of the one or more ML models. The one or more variables are based on the information associated with the one or more ML models, and the at least one modification of the one or more variables facilitates at least partially correcting or preventing performance degradations of the at least one ML model.

In one embodiment, a network node for performing user equipment (UE) machine-learning (ML) model analysis is provided. The network node comprises a transceiver, a processor, and a memory, said memory containing instructions executable by the processor whereby the network node is operative to perform a method. The method comprises requesting a user equipment (UE) to report information associated with one or more machine-learning (ML) models operable by the UE; receiving, from the UE, the information associated with the one or more ML models operable by the UE; and sending, to the UE, a representation of at least one modification of one or more variables associated with at least one ML model of the one or more ML models. The one or more variables are based on the information associated with the one or more ML models, and the at least one modification of the one or more variables facilitates at least partially correcting or preventing the performance degradations of the at least one ML model.

Embodiments of a UE, a network node, and a wireless communication system are also provided according to the above method embodiments.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates exemplary ML model training and inference pipelines and their interactions within an ML model lifecycle management procedure, in accordance with some embodiments.

FIG. 2 illustrates an example of a communication system in accordance with some embodiments.

FIG. 3 illustrates an exemplary user equipment in accordance with some embodiments.

FIG. 4 illustrates an exemplary network node in accordance with some embodiments.

FIG. 5 is a block diagram of an exemplary host, which may be an embodiment of the host of FIG. 1, in accordance with various aspects described herein.

FIG. 6 is a block diagram illustrating an exemplary virtualization environment in which functions implemented by some embodiments may be virtualized.

FIG. 7 illustrates a communication diagram of an exemplary host communicating via a network node with a UE over a partially wireless connection in accordance with some embodiments.

FIG. 8 illustrates a signal sequence diagram among a network node, a UE, and a second network node in accordance with some embodiments.

FIG. 9 illustrates examples where a network node communicates a change in the transmission power of a neighboring cell to the UE, in accordance with some embodiments.

FIG. 10 illustrates examples where the network deployment such as beam ID mapping changes after training a UE's ML model, in accordance with some embodiments.

FIG. 11 illustrates an exemplary over-the-top signaling with a server node having data for training an ML-model, in accordance with some embodiments.

FIG. 12 is a flowchart illustrating a method performed by a UE in accordance with some embodiments.

FIG. 13 is a flowchart illustrating a method performed by a network node in accordance with some embodiments.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the invention may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As described above, AI/ML techniques are being developed to enhance the design of air-interfaces in wireless communication networks. When applying AI/ML techniques to air-interference use cases, different categories of collaboration between network nodes and UEs can be considered. In a first category, there is no collaboration between network nodes and UEs. In this case, a proprietary ML model operating with an existing standard air-interface is applied at one side of the communication network (e.g., at the UE side). And the ML model's life cycle management (e.g., model selection/training, model monitoring, model retraining, and model update) is performed at this one side (e.g., at the UE side) without assistance from other sides of the network (e.g., without assistance information provided by the network node). In a second category, there is limited collaboration between network nodes and UEs. In this case, an ML model is operating at one side of the communication network (e.g., at the UE side). This side that operates the ML model receives assistance from the other side(s) of the communication network (e.g., receives assistance information provided by a network node such as a gNB) for its ML model life cycle management (e.g., for training/retraining the AI model, model update, etc.). In a third category, there is a joint ML operation between different sides of the network (e.g., between network nodes and UEs). In this case, an ML model can be split with one part located at the network node side and the other part located at the UE side. Hence, the ML model may require joint training between the network node and the UE. In this third level, the ML model life cycle management involves both sides of a communication network (e.g., both the UE and the network node).

In the present disclosure, the second category (i.e., limited collaboration between network nodes and UEs) are used for illustration and discussion. In one embodiment, an ML model operating with the existing standard air-interface is placed at the UE side. The inference output of this ML model is reported from the UE to the network node. The inference output is sometimes also referred to as the predicted output, which is generated by a trained ML model based on certain input data. Based on this inference output, the network node performs one or more operations that can affect the current and/or subsequent wireless communications between the network node and the UE.

As an example, an ML-model based UCI (Uplink Control Information) report algorithm is deployed at a UE. The UCI may comprise HARQ-ACK (Hybrid Automatic Repeat Request-Acknowledgement), SR (Scheduling Request), and/or CSI. A UE uses the ML model to estimate the UCI and reports the estimation to its serving network node such as a gNB. Based on the received CQI (Channel Quality Information) report, the network node performs one or more operations such as link-adaptation, beam selection, or/and scheduling decisions for the next data transmission to, or reception from, this UE.

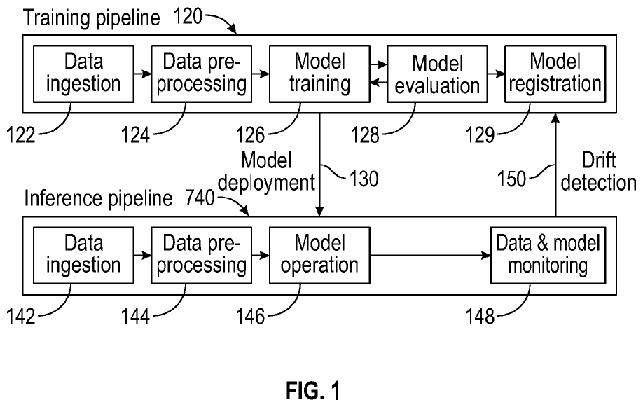

Building an ML model includes several development steps where the actual training of the ML model is one step in a training pipeline. Developing an ML model also involves the ML model's lifecycle management. This is illustrated in Error! Reference source not found.1, which illustrates exemplary ML model training and inference pipelines, and their interactions within a model lifecycle management procedure. As illustrated in FIG. 1, an ML model lifecycle management typically comprises a training (re-training) pipeline 720, a model deployment stage 730, an inference pipeline 740, and a drift detection stage 750.

In some embodiments, training (re-training) pipeline 120 includes several steps such as a data ingestion step 122, a data pre-processing step 124, a model training step 126, a model evaluation step 128, and a model registration step 129. In the data ingestion step 122, a device operating an ML model (e.g., a UE, a server, or a network node) gathers raw data (e.g., training data) from a data storage such as a database. Training data can be used by the ML model to learn patterns and relationships that exist within the data, so that a trained ML model can make accurate predictions of classifications on inference data (e.g., new data). Training data may include input data and corresponding output data. In some examples, after the ingestion of data to the device, there may also be an additional step that controls the validity of the gathered data. In the data pre-processing step 124, the device can apply some feature engineering to the gathered data. The feature engineering may include data normalization and possibly a data transformation required for the input data of the ML model. In the model training phase 126, the ML model can be trained based on the pre-processed data.

With reference still to FIG. 1, in the model evaluation step 128, the ML model's performance is evaluated (e.g., benchmarked with respect to certain baseline performance). The performance evaluation results can be used to make adjustments of the model training. Thus, the model training step 126 and the model evaluation step 128 can be iteratively performed until an acceptable level of performance (as previously exemplified) is achieved. Afterwards, the ML model is considered to be sufficiently trained to satisfy a performance requirement. The model registration step 129 then registers the ML model, including any corresponding AI/ML-meta data that provides information on how the AI/ML model was developed, and possibly AI/ML model evaluations performance outcomes.

FIG. 1 further illustrates that an ML model deployment stage 130, in which the trained (or re-trained) AI/ML model are deployed as a part of the inference pipeline 140. For example, the trained (or re-trained) ML model may be deployed to a UE for making inferences or predictions based on certain collected data. In one embodiment, the inference pipeline 140 includes a data ingestion step 142, a data pre-processing step 144, a model operation step 146, and data and model monitoring step 148. In the data ingestion step 142, a device operating an ML model (e.g., a UE, a server, or a network node) gathers raw data (e.g., inference data) from a data storage. Unlike training data, raw data or inference data can be new data that have not been encountered or used by the ML model. A trained ML model can make predictions or classifications based on the raw data or inference data.

The data pre-processing step 144 is typically identical to corresponding data pre-processing step 124 that occurs in the training pipeline 120. In the model operation step 146, the ML model uses the trained and deployed model in an operational mode such that it makes predictions or classifications from the pre-processed inference data (and/or any features obtained based on the raw inference data). In the data and model monitoring step 148, the device can validate that the inference data are from a distribution that aligns well with the training data, as well as monitor the ML model outputs for detecting any performance drifts or operational drifts. At the drift detection stage 150, the device can provide information about any drifts in the model operations. For instance, the device can provide such information to a device implementing the training pipeline 120 such that the ML model can be retrained to at least partially correcting the performance drifts or operational drifts.

As described above, ML models can be trained and deployed for enhancing system performances in various use cases. One such use case is for enhancing the performance of beam prediction, which is a process of predicting the optical direction of a radio frequency (RF) beam to establish a strong and stable connection between a UE and a network node. In such a use case, a device can use an ML model to improve beam predictions, thereby reducing its measurement related to beamforming. In NR, one can request a device to measure a set of CSI-RS (channel state information-reference signal) beams. A stationary device typically experiences less variations in beam quality in comparison to a moving device. The stationary device can therefore save battery and reduce the number of beam measurements by instead using an ML model to predict the strength without an explicit measurement. It can do this, for example, by measuring a subset of the beams and predicting the rest of the beams. For instance, a device can measure a subset of beam pairs, and use an AI/ML model to estimate qualities of all beam pairs. By using the AI/ML models, the number of measurements can be reduced up to about 75%. More details of leveraging AI/ML models to enhance communication functions are described in “Study on AI Based PHY Layer Enhancement for Rel-18” from 3GPP TSG-RAN WG Meeting #90-e, Dec. 7-11, 2020, available at https://www.3gpp.org/ftp/tsg_ran/TSG_RAN/TSGR_90e/Docs/RP-202650.zip, (e.g., on slide 7), the entire content of which is incorporated herein by reference for all purposes.

There currently exist certain challenge(s) in applying AI/ML technologies to air-interface use cases. With the expected increased UE capabilities, there is a risk that ML models may not perform adequately after they are deployed to the device. When a UE executes an ML model, there might be some unforeseen events, unknown to the device, that cause the ML model's performance to degrade. Using beam prediction as an example, a UE may detect that it cannot accurately predict beams anymore. This may be due to a number of factors including, e.g., a CSI-RS-ID change in a network node. That is, the IDs related to how the network node maps the antennas onto the beams for a certain reference signal have changed. Hence, the UE cannot directly apply its learning from the previous ML model trainings for making future predictions or inferences.

In some cases, the challenge of applying AI/ML techniques to air-interface use cases is that the UE may have to rely on features from the network node, but the UE is not aware when the network node decides to change the properties of these features. As a result, the trained ML models deployed to the UE cannot make accurate predictions. One method to at least mitigate this issue is to collect new data and train a new ML model upon detecting performance degradations of the existing ML model deployed to the UE. However, such a method of training a new ML model may be time consuming and costly. Moreover, in some scenarios, the deployed ML model may be working properly, but there might be some temporary, or deployment-related, changes that can be mitigated without initiating a process of new UE data collection and model training. Furthermore, it can be challenging for a device to understand whether a performance degradation is due to hardware impairments in the device (e.g., increased antenna phase noise over time), or if the performance degradation is due to network deployment changes. Without a correct understanding of the cause of the performance degradation, the UE may try to mitigate the “wrong” error source for the model performance degradation.

Currently, there is no method that enables the network node to acquire needed information on one or more ML models deployed to the UE. Such information can prevent, for example, the execution of unnecessary data collection and model retraining tasks upon detection of a performance degradation, and prevent an ML model performance degradation even before it occurs.

Various aspects of the present disclosure and their embodiments are described in greater details below. Embodiments of the present disclosure may provide solutions to the aforementioned and/or other challenges related to the performance degradation of ML models. In one embodiment, the present disclosure describes a method that facilitates the acquisition of information related to the UE models by the network node. With the acquired information, the network node can proactively detect ML model's performance degradation and an analysis of the potential root cause for the degradation. The network node can indicate such root cause to the UE by, e.g., communicating to the UE relevant changes that may have affected, or will affect, the model performance. In one example, based on the ML model information obtained from the UE together with other related information collected/available at the network node, the network node may transmit model assistance information to the UE. Such assistance information can be used by the UE to modify the model features to start data collection and/or start retraining the ML-model by the UE itself or via a second node. The method described herein thus facilitates an improved ML model performance.

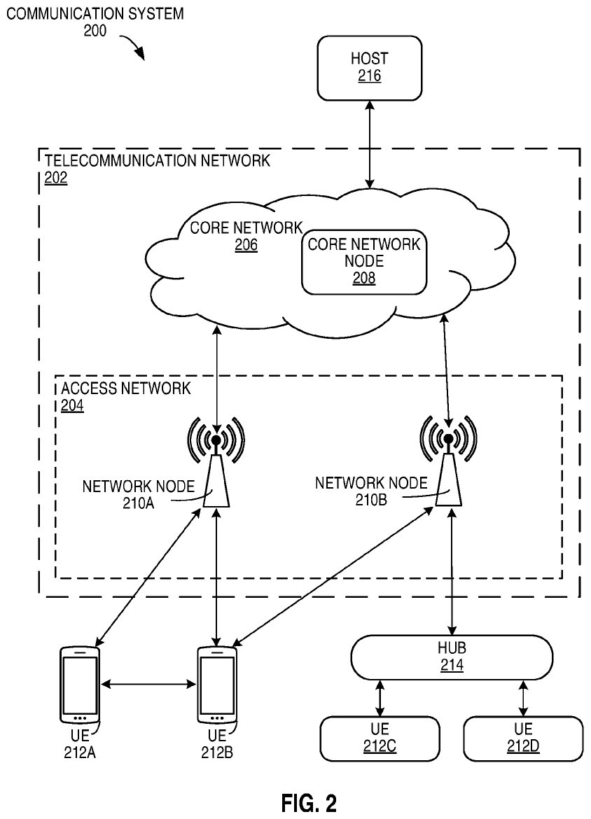

FIG. 2 shows an example of a communication system 200 in accordance with some embodiments.

In the example, the communication system 200 includes a telecommunication network 202 that includes an access network 204, such as a radio access network (RAN), and a core network 206, which includes one or more core network nodes 208. The access network 204 includes one or more access network nodes, such as network nodes 210a and 210b (one or more of which may be generally referred to as network nodes 210), or any other similar 3^{rd} Generation Partnership Project (3GPP) access node or non-3GPP access point. The network nodes 210 facilitate direct or indirect connection of user equipment (UE), such as by connecting UEs 212a, 212b, 212c, and 212d (one or more of which may be generally referred to as UEs 212) to the core network 206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 200 may include any number of wired or wireless networks, network nodes, UEs, and/or any other components or systems that may facilitate or participate in the communication of data and/or signals whether via wired or wireless connections. The communication system 200 may include and/or interface with any type of communication, telecommunication, data, cellular, radio network, and/or other similar type of system.

The UEs 212 may be any of a wide variety of communication devices, including wireless devices arranged, configured, and/or operable to communicate wirelessly with the network nodes 210 and other communication devices. Similarly, the network nodes 210 are arranged, capable, configured, and/or operable to communicate directly or indirectly with the UEs 212 and/or with other network nodes or equipment in the telecommunication network 202 to enable and/or provide network access, such as wireless network access, and/or to perform other functions, such as administration in the telecommunication network 202.

In the depicted example, the core network 206 connects the network nodes 210 to one or more hosts, such as host 216. These connections may be direct or indirect via one or more intermediary networks or devices. In other examples, network nodes may be directly coupled to hosts. The core network 206 includes one more core network nodes (e.g., core network node 208) that are structured with hardware and software components. Features of these components may be substantially similar to those described with respect to the UEs, network nodes, and/or hosts, such that the descriptions thereof are generally applicable to the corresponding components of the core network node 208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 216 may be under the ownership or control of a service provider other than an operator or provider of the access network 204 and/or the telecommunication network 202, and may be operated by the service provider or on behalf of the service provider. The host 216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 200 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 202 is a cellular network that implements 3GPP standardized features. Accordingly, the telecommunications network 202 may support network slicing to provide different logical networks to different devices that are connected to the telecommunication network 202. For example, the telecommunications network 202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 212 are configured to transmit and/or receive information without direct human interaction. For instance, a UE may be designed to transmit information to the access network 204 on a predetermined schedule, when triggered by an internal or external event, or in response to requests from the access network 204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 214 communicates with the access network 204 to facilitate indirect communication between one or more UEs (e.g., UE 212c and/or 212d) and network nodes (e.g., network node 210b). In some examples, the hub 214 may be a controller, router, content source and analytics, or any of the other communication devices described herein regarding UEs. For example, the hub 214 may be a broadband router enabling access to the core network 206 for the UEs. As another example, the hub 214 may be a controller that sends commands or instructions to one or more actuators in the UEs. Commands or instructions may be received from the UEs, network nodes 210, or by executable code, script, process, or other instructions in the hub 214. As another example, the hub 214 may be a data collector that acts as temporary storage for UE data and, in some embodiments, may perform analysis or other processing of the data. As another example, the hub 214 may be a content source. For example, for a UE that is a VR headset, display, loudspeaker or other media delivery device, the hub 214 may retrieve VR assets, video, audio, or other media or data related to sensory information via a network node, which the hub 214 then provides to the UE either directly, after performing local processing, and/or after adding additional local content. In still another example, the hub 214 acts as a proxy server or orchestrator for the UEs, in particular in if one or more of the UEs are low energy IoT devices.

The hub 214 may have a constant/persistent or intermittent connection to the network node 210b. The hub 214 may also allow for a different communication scheme and/or schedule between the hub 214 and UEs (e.g., UE 212c and/or 212d), and between the hub 214 and the core network 206. In other examples, the hub 214 is connected to the core network 206 and/or one or more UEs via a wired connection. Moreover, the hub 214 may be configured to connect to an M2M service provider over the access network 204 and/or to another UE over a direct connection. In some scenarios, UEs may establish a wireless connection with the network nodes 210 while still connected via the hub 214 via a wired or wireless connection. In some embodiments, the hub 214 may be a dedicated hub—that is, a hub whose primary function is to route communications to/from the UEs from/to the network node 210b. In other embodiments, the hub 214 may be a non-dedicated hub—that is, a device which is capable of operating to route communications between the UEs and network node 210b, but which is additionally capable of operating as a communication start and/or end point for certain data channels.

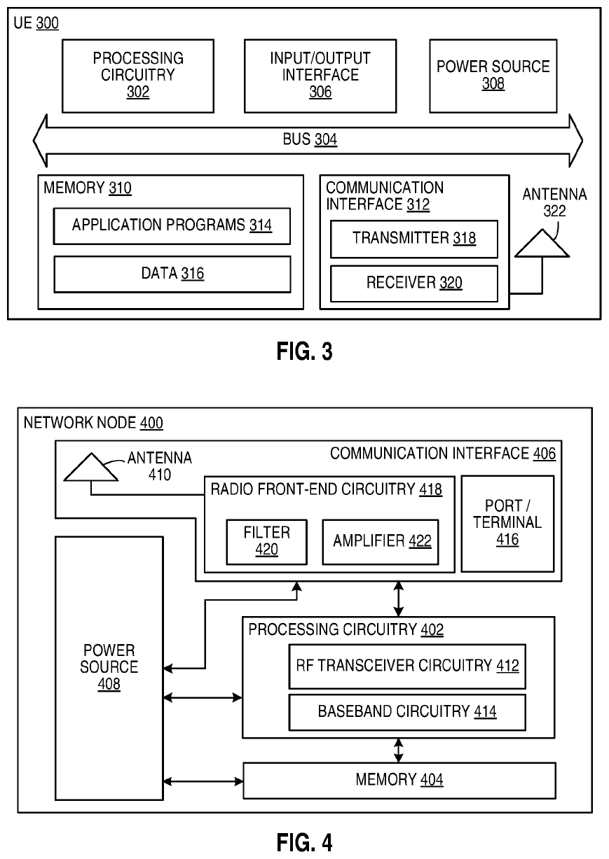

FIG. 3 shows a UE 300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 300 includes processing circuitry 302 that is operatively coupled via a bus 304 to an input/output interface 306, a power source 308, a memory 310, a communication interface 312, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 302 may include multiple central processing units (CPUs).

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the UE 300 via input circuitry or an interface such as an electrical power cable. Delivering power may be, for example, for charging of the power source 308. Power circuitry may perform any formatting, converting, or other modification to the power from the power source 308 to make the power suitable for the respective components of the UE 300 to which power is supplied.

The memory 310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the UE 300, any of a variety of various operating systems or combinations of operating systems.

The memory 310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 310 may allow the UE 300 to access instructions, application programs and the like, stored on transitory or non-transitory memory media, to off-load data, or to upload data. An article of manufacture, such as one utilizing a communication system may be tangibly embodied as or in the memory 310, which may be or comprise a device-readable storage medium.

The processing circuitry 302 may be configured to communicate with an access network or other network using the communication interface 312. The communication interface 312 may comprise one or more communication subsystems and may include or be communicatively coupled to an antenna 322. The communication interface 312 may include one or more transceivers used to communicate, such as by communicating with one or more remote transceivers of another device capable of wireless communication (e.g., another UE or a network node in an access network). Each transceiver may include a transmitter 318 and/or a receiver 320 appropriate to provide network communications (e.g., optical, electrical, frequency allocations, and so forth). Moreover, the transmitter 318 and receiver 320 may be coupled to one or more antennas (e.g., antenna 322) and may share circuit components, software or firmware, or alternatively be implemented separately.

In the illustrated embodiment, communication functions of the communication interface 312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 300 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 4 shows a network node 400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 400 includes a processing circuitry 402, a memory 404, a communication interface 406, and a power source 408. The network node 400 may be composed of multiple physically separate components (e.g., a NodeB component and a RNC component, or a BTS component and a BSC component, etc.), which may each have their own respective components. In certain scenarios in which the network node 400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 400 may be configured to support multiple radio access technologies (RATs). In such embodiments, some components may be duplicated (e.g., separate memory 404 for different RATs) and some components may be reused (e.g., a same antenna 410 may be shared by different RATs). The network node 400 may also include multiple sets of the various illustrated components for different wireless technologies integrated into network node 400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 400.

The processing circuitry 402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 400 components, such as the memory 404, to provide network node 400 functionality.

In some embodiments, the processing circuitry 402 includes a system on a chip (SOC). In some embodiments, the processing circuitry 402 includes one or more of radio frequency (RF) transceiver circuitry 412 and baseband processing circuitry 414. In some embodiments, the radio frequency (RF) transceiver circuitry 412 and the baseband processing circuitry 414 may be on separate chips (or sets of chips), boards, or units, such as radio units and digital units. In alternative embodiments, part or all of RF transceiver circuitry 412 and baseband processing circuitry 414 may be on the same chip or set of chips, boards, or units.

The memory 404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 402. The memory 404 may store any suitable instructions, data, or information, including a computer program, software, an application including one or more of logic, rules, code, tables, and/or other instructions capable of being executed by the processing circuitry 402 and utilized by the network node 400. The memory 404 may be used to store any calculations made by the processing circuitry 402 and/or any data received via the communication interface 406. In some embodiments, the processing circuitry 402 and memory 404 are integrated.

The communication interface 406 is used in wired or wireless communication of signaling and/or data between a network node, access network, and/or UE. As illustrated, the communication interface 406 comprises port(s)/terminal(s) 416 to send and receive data, for example to and from a network over a wired connection. The communication interface 406 also includes radio front-end circuitry 418 that may be coupled to, or in certain embodiments a part of, the antenna 410. Radio front-end circuitry 418 comprises filters 420 and amplifiers 422. The radio front-end circuitry 418 may be connected to an antenna 410 and processing circuitry 402. The radio front-end circuitry may be configured to condition signals communicated between antenna 410 and processing circuitry 402. The radio front-end circuitry 418 may receive digital data that is to be sent out to other network nodes or UEs via a wireless connection. The radio front-end circuitry 418 may convert the digital data into a radio signal having the appropriate channel and bandwidth parameters using a combination of filters 420 and/or amplifiers 422. The radio signal may then be transmitted via the antenna 410. Similarly, when receiving data, the antenna 410 may collect radio signals which are then converted into digital data by the radio front-end circuitry 418. The digital data may be passed to the processing circuitry 402. In other embodiments, the communication interface may comprise different components and/or different combinations of components.

In certain alternative embodiments, the network node 400 does not include separate radio front-end circuitry 418, instead, the processing circuitry 402 includes radio front-end circuitry and is connected to the antenna 410. Similarly, in some embodiments, all or some of the RF transceiver circuitry 412 is part of the communication interface 406. In still other embodiments, the communication interface 406 includes one or more ports or terminals 416, the radio front-end circuitry 418, and the RF transceiver circuitry 412, as part of a radio unit (not shown), and the communication interface 406 communicates with the baseband processing circuitry 414, which is part of a digital unit (not shown).

The antenna 410 may include one or more antennas, or antenna arrays, configured to send and/or receive wireless signals. The antenna 410 may be coupled to the radio front-end circuitry 418 and may be any type of antenna capable of transmitting and receiving data and/or signals wirelessly. In certain embodiments, the antenna 410 is separate from the network node 400 and connectable to the network node 400 through an interface or port.

The antenna 410, communication interface 406, and/or the processing circuitry 402 may be configured to perform any receiving operations and/or certain obtaining operations described herein as being performed by the network node. Any information, data and/or signals may be received from a UE, another network node and/or any other network equipment. Similarly, the antenna 410, the communication interface 406, and/or the processing circuitry 402 may be configured to perform any transmitting operations described herein as being performed by the network node. Any information, data and/or signals may be transmitted to a UE, another network node and/or any other network equipment.

The power source 408 provides power to the various components of network node 400 in a form suitable for the respective components (e.g., at a voltage and current level needed for each respective component). The power source 408 may further comprise, or be coupled to, power management circuitry to supply the components of the network node 400 with power for performing the functionality described herein. For example, the network node 400 may be connectable to an external power source (e.g., the power grid, an electricity outlet) via an input circuitry or interface such as an electrical cable, whereby the external power source supplies power to power circuitry of the power source 408. As a further example, the power source 408 may comprise a source of power in the form of a battery or battery pack which is connected to, or integrated in, power circuitry. The battery may provide backup power should the external power source fail.

Embodiments of the network node 400 may include additional components beyond those shown in FIG. 4 for providing certain aspects of the network node's functionality, including any of the functionality described herein and/or any functionality necessary to support the subject matter described herein. For example, the network node 400 may include user interface equipment to allow input of information into the network node 400 and to allow output of information from the network node 400. This may allow a user to perform diagnostic, maintenance, repair, and other administrative functions for the network node 400.

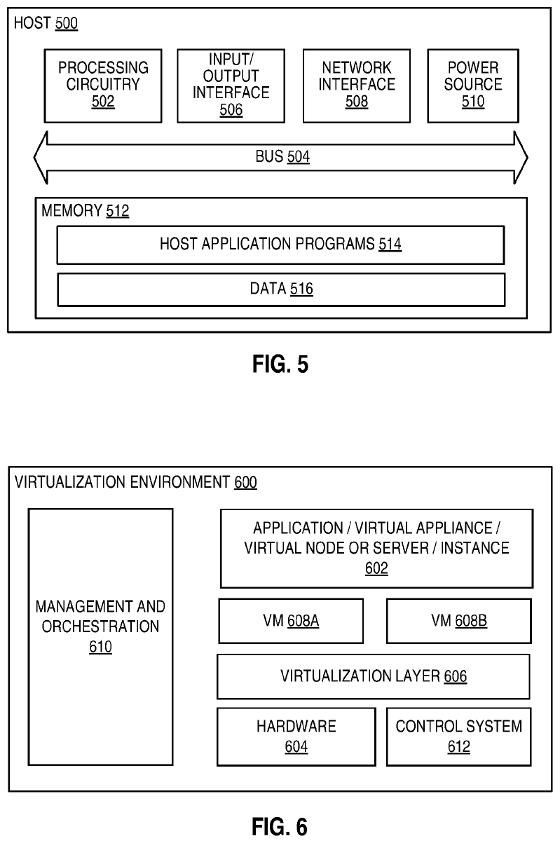

FIG. 5 is a block diagram of a host 500, which may be an embodiment of the host 216 of FIG. 2, in accordance with various aspects described herein. As used herein, the host 500 may be or comprise various combinations hardware and/or software, including a standalone server, a blade server, a cloud-implemented server, a distributed server, a virtual machine, container, or processing resources in a server farm. The host 500 may provide one or more services to one or more UEs.

The host 500 includes processing circuitry 502 that is operatively coupled via a bus 504 to an input/output interface 506, a network interface 508, a power source 510, and a memory 512. Other components may be included in other embodiments. Features of these components may be substantially similar to those described with respect to the devices of previous figures, such as FIGS. 3 and 4, such that the descriptions thereof are generally applicable to the corresponding components of host 500.

The memory 512 may include one or more computer programs including one or more host application programs 514 and data 516, which may include user data, e.g., data generated by a UE for the host 500 or data generated by the host 500 for a UE. Embodiments of the host 500 may utilize only a subset or all of the components shown. The host application programs 514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 514 may also provide for user authentication and licensing checks and may periodically report health, routes, and content availability to a central node, such as a device in or on the edge of a core network. Accordingly, the host 500 may select and/or indicate a different host for over-the-top services for a UE. The host application programs 514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 6 is a block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 602 (which may alternatively be called software instances, virtual appliances, network functions, virtual nodes, virtual network functions, etc.) are run in the virtualization environment 600 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 606 (also referred to as hypervisors or virtual machine monitors (VMMs)), provide VMs 608a and 608b (one or more of which may be generally referred to as VMs 608), and/or perform any of the functions, features and/or benefits described in relation with some embodiments described herein. The virtualization layer 606 may present a virtual operating platform that appears like networking hardware to the VMs 608.

The VMs 608 comprise virtual processing, virtual memory, virtual networking or interface and virtual storage, and may be run by a corresponding virtualization layer 606. Different embodiments of the instance of a virtual appliance 602 may be implemented on one or more of VMs 608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 608 may be a software implementation of a physical machine that runs programs as if they were executing on a physical, non-virtualized machine. Each of the VMs 608, and that part of hardware 604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 608 on top of the hardware 604 and corresponds to the application 602.

Hardware 604 may be implemented in a standalone network node with generic or specific components. Hardware 604 may implement some functions via virtualization. Alternatively, hardware 604 may be part of a larger cluster of hardware (e.g., such as in a data center or CPE) where many hardware nodes work together and are managed via management and orchestration 610, which, among others, oversees lifecycle management of applications 602. In some embodiments, hardware 604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 612 which may alternatively be used for communication between hardware nodes and radio units.

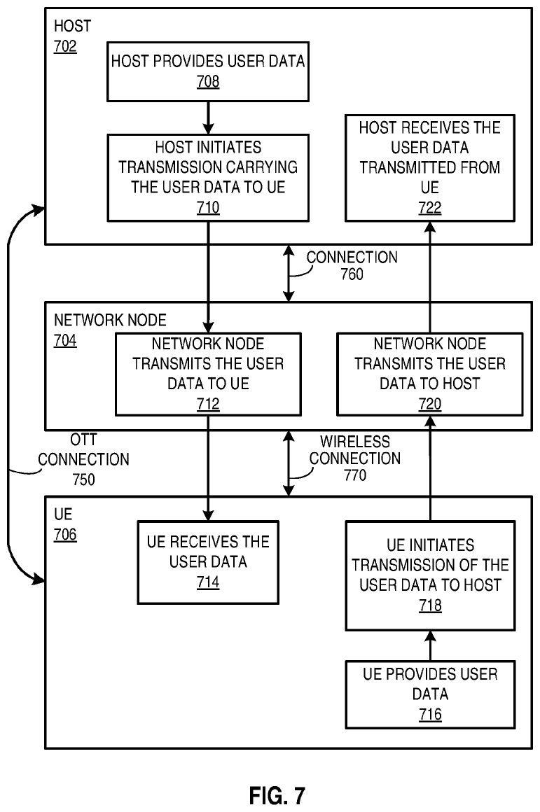

FIG. 7 shows a communication diagram of a host 702 communicating via a network node 704 with a UE 706 over a partially wireless connection in accordance with some embodiments. Example implementations, in accordance with various embodiments, of the UE (such as a UE 212a of FIG. 2 and/or UE 300 of FIG. 3), network node (such as network node 210a of FIG. 2 and/or network node 400 of FIG. 4), and host (such as host 216 of FIG. 2 and/or host 500 of FIG. 5) discussed in the preceding paragraphs will now be described with reference to FIG. 7.

Like host 500, embodiments of host 702 include hardware, such as a communication interface, processing circuitry, and memory. The host 702 also includes software, which is stored in or accessible by the host 702 and executable by the processing circuitry. The software includes a host application that may be operable to provide a service to a remote user, such as the UE 706 connecting via an over-the-top (OTT) connection 750 extending between the UE 706 and host 702. In providing the service to the remote user, a host application may provide user data which is transmitted using the OTT connection 750.

The network node 704 includes hardware enabling it to communicate with the host 702 and UE 706. The connection 760 may be direct or pass through a core network (like core network 206 of FIG. 2) and/or one or more other intermediate networks, such as one or more public, private, or hosted networks. For example, an intermediate network may be a backbone network or the Internet.

The UE 706 includes hardware and software, which is stored in or accessible by UE 706 and executable by the UE's processing circuitry. The software includes a client application, such as a web browser or operator-specific “app” that may be operable to provide a service to a human or non-human user via UE 706 with the support of the host 702. In the host 702, an executing host application may communicate with the executing client application via the OTT connection 750 terminating at the UE 706 and host 702. In providing the service to the user, the UE's client application may receive request data from the host's host application and provide user data in response to the request data. The OTT connection 750 may transfer both the request data and the user data. The UE's client application may interact with the user to generate the user data that it provides to the host application through the OTT connection 750.

The OTT connection 750 may extend via a connection 760 between the host 702 and the network node 704 and via a wireless connection 770 between the network node 704 and the UE 706 to provide the connection between the host 702 and the UE 706. The connection 760 and wireless connection 770, over which the OTT connection 750 may be provided, have been drawn abstractly to illustrate the communication between the host 702 and the UE 706 via the network node 704, without explicit reference to any intermediary devices and the precise routing of messages via these devices.

As an example of transmitting data via the OTT connection 750, in step 708, the host 702 provides user data, which may be performed by executing a host application. In some embodiments, the user data is associated with a particular human user interacting with the UE 706. In other embodiments, the user data is associated with a UE 706 that shares data with the host 702 without explicit human interaction. In step 710, the host 702 initiates a transmission carrying the user data towards the UE 706. The host 702 may initiate the transmission responsive to a request transmitted by the UE 706. The request may be caused by human interaction with the UE 706 or by operation of the client application executing on the UE 706. The transmission may pass via the network node 704, in accordance with the teachings of the embodiments described throughout this disclosure. Accordingly, in step 712, the network node 704 transmits to the UE 706 the user data that was carried in the transmission that the host 702 initiated, in accordance with the teachings of the embodiments described throughout this disclosure. In step 714, the UE 706 receives the user data carried in the transmission, which may be performed by a client application executed on the UE 706 associated with the host application executed by the host 702.

In some examples, the UE 706 executes a client application which provides user data to the host 702. The user data may be provided in reaction or response to the data received from the host 702. Accordingly, in step 716, the UE 706 may provide user data, which may be performed by executing the client application. In providing the user data, the client application may further consider user input received from the user via an input/output interface of the UE 706. Regardless of the specific manner in which the user data was provided, the UE 706 initiates, in step 718, transmission of the user data towards the host 702 via the network node 704. In step 720, in accordance with the teachings of the embodiments described throughout this disclosure, the network node 704 receives user data from the UE 706 and initiates transmission of the received user data towards the host 702. In step 722, the host 702 receives the user data carried in the transmission initiated by the UE 706.

One or more of the various embodiments improve the performance of OTT services provided to the UE 706 using the OTT connection 750, in which the wireless connection 770 forms the last segment. More precisely, the teachings of these embodiments may improve the data rate, date communication efficiencies, real-time communication capabilities, and reduce power consumption, and thereby provide benefits such as reduced user waiting time, relaxed restriction on file size, improved content resolution, better responsiveness, reduced error rate or performance degradations, improved collaboration between network and UEs, and extended battery lifetime].

In an example scenario, factory status information may be collected and analyzed by the host 702. As another example, the host 702 may process audio and video data which may have been retrieved from a UE for use in creating maps. As another example, the host 702 may collect and analyze real-time data to assist in controlling vehicle congestion (e.g., controlling traffic lights). As another example, the host 702 may store surveillance video uploaded by a UE. As another example, the host 702 may store or control access to media content such as video, audio, VR or AR which it can broadcast, multicast or unicast to UEs. As other examples, the host 702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 750 between the host 702 and UE 706, in response to variations in the measurement results. The measurement procedure and/or the network functionality for reconfiguring the OTT connection may be implemented in software and hardware of the host 702 and/or UE 706. In some embodiments, sensors (not shown) may be deployed in or in association with other devices through which the OTT connection 750 passes; the sensors may participate in the measurement procedure by supplying values of the monitored quantities exemplified above, or supplying values of other physical quantities from which software may compute or estimate the monitored quantities. The reconfiguring of the OTT connection 750 may include message format, retransmission settings, preferred routing etc.; the reconfiguring need not directly alter the operation of the network node 704. Such procedures and functionalities may be known and practiced in the art. In certain embodiments, measurements may involve proprietary UE signaling that facilitates measurements of throughput, propagation times, latency and the like, by the host 702. The measurements may be implemented in that software causes messages to be transmitted, in particular empty or ‘dummy’ messages, using the OTT connection 750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

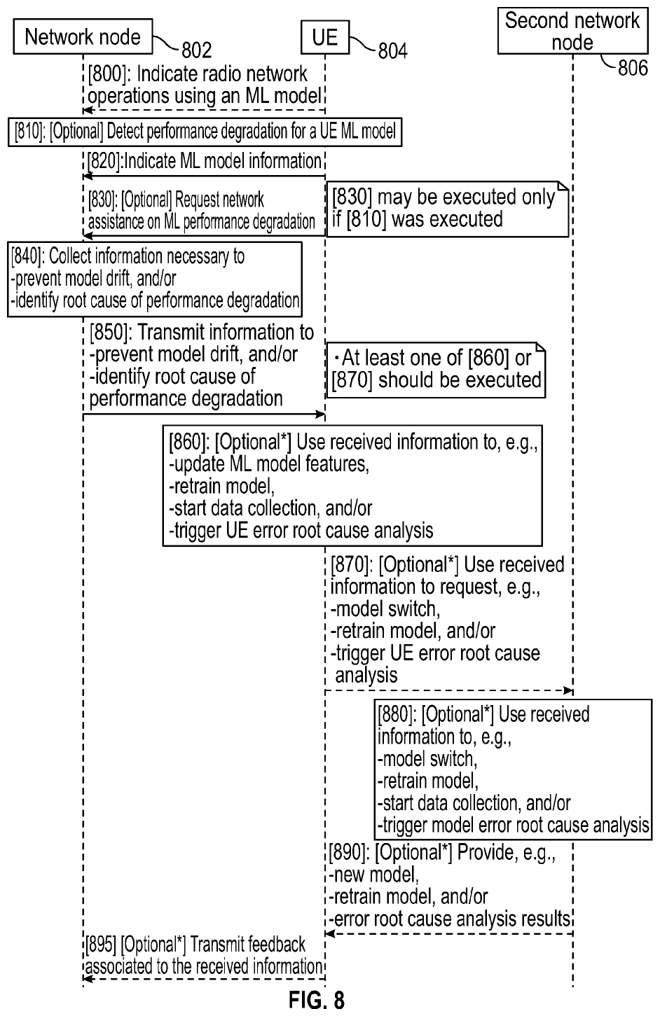

As described below in greater detail using FIGS. 8-12, the present disclosure enables a UE to provide a network node with information associated with one or more ML models operable by the UE. In some embodiments, the UE-provided information enables the network node to proactively detect performance degradations of the UE's ML model(s). The network node can communicate to the UE relevant changes that may affect the ML model's performance. In some embodiments, the network node may also use the ML model information shared by the UE to perform an analysis to identify a potential root cause for the performance degradations and indicate such root cause to the UE. In some embodiments, the availability of the information shared by the UE may prevent unnecessary ML model retraining. For example, the network node may determine that the performance degradation cannot be corrected by ML mode retraining. Instead, the network node may indicate to the UE how the UE should modify its model input features to match the new network deployment scenario, leading to a reduced need for the ML model retraining and preventing of the model drift. In another example, the network node may provide to the UE a recommendation on the features that the UE should include or exclude when retraining the ML model, leading to a reduced need of data collection for ML model retraining and/or for deploying a new ML model. In another example, the network node may indicate to the UE that the performance degradation is likely caused by the UE but not the network node. This indication may trigger the UE or a second network node (e.g., a server node) to start an error cause analysis procedure at the UE. In some examples, the availability of the information provided by the UE can also enable the UE to train a new model without collecting new data, e.g., by filtering out some of the features that caused the performance degradation.

In the present disclosure, the terms “ML-model” and “AI-model” are used interchangeably. For simplicity, both the ML model and the AI-model may be referred to as an ML model, an AI/ML model, or an AI/ML algorithm. An AI/ML model is a model or algorithm that has a functionality or a part of a functionality that is deployed or implemented in a first node (e.g., a UE). This first node can receive a message from a second node (e.g., a network node) indicating that the functionality is not being performed correctly or that there is a performance degradation. Further, an AI/ML model can be defined as a feature or a part of a feature that is implemented or supported in a first node. This first node can indicate the feature version to a second node. If the ML-model is updated, the feature version may be changed by the first node.

FIG. 8 illustrates a signal sequence diagram among several nodes including a network node 802, a UE 804, and a second network node 806 in accordance with some embodiments. Network node 802 and second network node 806 can be implemented using any network nodes described above (e.g., network node 400 shown in FIG. 4). UE 804 can be implemented using any UE described above (e.g., UE 300 shown in FIG. 3). The method steps shown in FIG. 8 are described in more detail below. The concept of “network” or “network node” in the present disclosure can be understood as a generic network node, a gNB, a base station, a unit within the base station that performs at least one ML model operation, a relay node, a core network node, a core network node that performs at least one ML operation, or a device supporting device-to-device (D2D) communication. In FIG. 8, a first node is illustrated by UE 804, a second node is illustrated by network node 802, and a third node is illustrated by second network node 806. It is understood that the first, second, and third node may be different in other examples (e.g., a first node may be a network node while a second node may be a UE). The orders of the steps shown in FIG. 8 may also be altered or rearranged. The steps shown in FIG. 8 may be eliminated and/or additional steps may be added.

With reference to FIG. 8, in step 800, UE 804 sends information indicating one or more radio network operations (RNOs) that use one or more ML models. The one or more radio network operations (RNOs) that use one or more ML models include, for example, radio resource managements, network performance data analysis, connectivity management, etc. UE 804 may send the information indicating the one or more RNOs to the network node 802 with or without a request from network node 802. For instance, network node 802 may request UE 804 to report which operations UE 804 is currently executing or capable of executing based on an ML model. In one example, network node 802 may configure UE 804 to indicate whether and which information contained in one or more of the UE reports comprises information generated with an ML model. Examples of UE reports comprise reports associated with radio resource managements, UE measurements, mobility operations, (e.g., handover reports, link failure reports, etc.), a random access operation (e.g., random access channel (RACH) reports), dual or multi-connectivity operations, beamforming operations, radio resource control (RRC) state handling, traffic control, energy efficiency operations, and the type of information that has been determined based on an ML model.

In some examples, network node 802 can also instruct UE 804 to report information associated with the ML model(s) used for one or more specific operations. This information includes, for example, information determined by the one or more ML models (e.g., predictions or estimates provided by the models), information associated with configurations of the one or more ML models (e.g., the model settings, the configuration date, etc.), and/or information associated with performance of the one or more ML models (e.g., one or more model performance metrics or measurements). Also, network node 802 can request UE 804 to identify other nodes (e.g., other network nodes) with which UE 804 has previously used the same or similar ML models. The identification of other nodes can be used by network node 802 to obtain additional information related to the ML model, which may be useful for, e.g., detecting a potential performance degradation associated with the ML-model.

In some examples, UE 804 sends the information in step 800 to network node 802 in a periodical, non-periodical, or event-triggered manner. For instance, according to a performance monitoring schedule, UE 804 may send the information in step 800 to network node 802 without receiving a request from network node 802.

With continued reference to FIG. 8, in step 810, one or both network node 802 and UE 804 can detect performance degradations for a UE ML model based on the aforementioned ML model information shared by UE 804. Step 810 can be an optional step. In one example, network node 802 detects performance degradations based on information received from UE 804 in step 800. For instance, the performance degradation may be detected based on one or more outputs predicted by the one or more ML models; actual measurements of one or more parameters associated with performance monitoring of the one or more ML models; historical data associated with the performance of the one or more ML models; and data associated with performance of a corresponding ML model of one or more other UEs. For instance, based on comparison of one or more outputs predicted by the ML models and actual measurements of parameters associated with performance monitoring of the ML models, network node 802 can detect possible performance degradations of the one or more ML models. Using Reference Signal Received Power (RSRP) as an example, network node 802 receives, from UE 804, one or more predictions of RSRP per beam (e.g., Y′(0), Y′(1), . . . , Y′(N)), and one or more parameters corresponding to actual measurements of RSRP per beam (Y(0), Y(1), . . . , Y(M)). By comparing the predictions of the RSRP per beam and the actual measurements of the RSRP per beam, network node 802 can detect possible performance degradations of the one or more ML models used for RSRP predictions at UE 804. In some examples, for detecting possible performance degradations, the predictions of the ML models can be compared to historical data associated with the performance of the ML models and/or data associated with performance of a corresponding ML model of one or more other UEs. It is understood that network node 802 and/or UE 804 can use any of the performance evaluation methods to determine that a certain ML model has experienced a performance degradation.

With continued reference to FIG. 8, upon detection of the performance degradation of UE 804's one or more ML models, in step 820, UE 804 sends information associated with one or more ML models operable by UE 804 to network node 802 for further analysis. As described above step 810 may be optional. Thus, in some examples, UE 804 can send information associated with the one or more ML models to network node 802 without detection of any performance degradation. In some examples, UE 804 sends the information in response to receiving a request from network node 802. In some other examples, UE 804 sends the information without receiving a request from network node 802.

The information sent by UE 804 in step 820 may comprise one or more of feature information used by the one or more ML models; information related to data collection by the UE 804; and model-related information of the one or more ML models. Feature information used by the ML models refers to any of the inputs used by the ML models for training and/or for making inferences or predictions. In some examples, the feature information may include measurements of an NR cell, SSB (Synchronization Signal Block), and/or CSI-RS. For instance, the feature information may include a unique identifier for the reference signal (e.g., the physical cell ID (CID), SSB-ID, and/or CSI-RS ID) and the type of measurement (e.g., signal strength, an angle-of-arrival, a delay spread etc.). The feature information may also include geolocation information such as the UE's physical location, the mobility information (e.g., the UE's moving speed); and/or sensor data (e.g., Inertial Measurement Unit, or IMU, data). In some examples, UE 804 can send the model input (as a part of the feature information) using 3GPP-defined measurement objects. One or more ML models can use UE's location measurements and serving/neighboring cell radio measurements as input.

In some examples, UE 804 can send the feature information with associated feature importance information. The feature important information may be represented by, e.g., an importance value such as the Gini importance metric, commonly used when using decision tree-based ML models (e.g., random forests), and/or the SHAP (SHapley Additive explanations) feature values; and/or any other types of importance metrics relative to other features. The Gini importance metric is calculated as the total reduction of the impurity in the decision tree that can be attributed to a particular feature. The SHAP feature values measure the impact of each feature on the model output in a local context, i.e., for a particular input or prediction. For example, an RSRP measurement on a first cell may have an importance value of “I”, while the second cell may have an importance value of “2I”. Thus, the measurement on the first cell is more important than the measurements on the second cell.

In some examples, in step 820, UE 804 may send to network node 802 information related to the data collection performed by UE 804. Information on the data collected by UE 804 can be used by network node 802 to check if any special event has occurred during the data collection time window. Such events may include, for example, temporary failures (e.g., beam failures, radio link failures, or the like) during data collection time window and/or switching off of one or more cells. In some examples, the UE 804 can send network node 802 information related to the data collection time window including timestamps associated with the start time and stop time of the data collection, the number of samples for each time-window during which data were collected, and/or any other data collection time window related information. In some examples, UE 804 can send network node 802 information related to the location where the data collection was performed, such as the cell IDs, potential UE 804's geolocation information, or the like. UE 804 may also send network node 802 the collected range of values for each feature, such as the maximum, minimum, and mean values; a probability density function (PDF) or cumulative distribution function (CDF) of values for each feature; or the like. UE 804 may also send network node 802 information related to the number of samples in the dataset collected.

In some examples, in step 820, UE 804 may send network node 802 model-related information of the one or more ML models. Such model-related information may include, for example, the number of model parameters, the model hyperparameters, and/or the data training and test set sizes. In some embodiments, the network node 802 may utilize this model-related information to compare the one or more ML models operated by UE 804 with the other models or algorithms, e.g., from a complexity standpoint.

In both steps 800 and 820 described above, UE 804 sends information to network node 802. In some examples, the information sent in step 820 may be different from those in step 800. For instance, the information sent in step 800 may be information associated with radio network operations, while the information sent in step 820 may be information associated with the ML models. In some examples, the information sent in steps 800 and 820 may be combined and thus UE 804 may send the combined information in one step. The network node 802 can process the information received in step 800 and/or 820 for other steps shown in FIG. 8, including, e.g., identifying a root cause for performance degradation of the one or more ML models.

With continued reference to FIG. 8, in an optional step 830, UE 804 can send network node 802 a request to identify a cause of the performance degradation of the one or more ML models deployed to UE 804. For example, if step 810 was performed by the UE 804 such that it detected the performance degradation by itself, UE 804 may send a request to network node 802 to assist UE 804 identifying the cause of the ML model(s) performance degradation. In some embodiments not illustrated in FIG. 8, this request may be preceded by a communication from the network node 802 where the performance degradation of an ML model is signaled. For instance, network node 802 may detect that there is performance degradation of the one or more ML models deployed to UE 804, and therefore indicate the performance degradation to UE 804 by sending an indication to UE 804. UE 804 may then request network node 802 to assist in identifying a cause of the performance degradation. In some embodiments, no such request from UE 804 may be needed. Network node 802, after detecting the performance degradation or being signaled with such a degradation, may begin identifying the cause of the performance degradation on its own.

With continued reference to FIG. 8, in step 840, network node 802 collects information for at least partially correcting or preventing performance degradation of the one or more ML models and/or for identifying root cause of the performance degradation. In some embodiments, the network node 802 may utilize the information collected in step 820 to determine the variables that may have an impact on the performance of the UE 804's ML model(s) and determine the root cause of the performance degradation.

In one example of determining the variables that may have an impact on the performance of the one or more ML models, if network node 802 is proactively operating to prevent performance degradations of the one or more ML models, the network node 802 may track modifications in any of the variables that may have an impact on the performance of the one or more ML models deployed to UE 804. In another example, if UE 804 has sent a request to network node 802 for provide assistance to identify the root cause of performance degradation, network node 802 may attempt to identify the cause of such degradation in one or more of the following manners. For instance, network node 802 can verify if there have been modifications, within the same time window when the performance degradation occurred, in any of the variables that may have an impact on the performance of UE 804. Network node 802 may also compare the ML model information for the same and/or other UEs collected in step 820 described above, and determine any differences that may likely suggest a cause for the performance degradation. In another example, network node 802 may compare the UE reported information to a network specific model capable of performing the same predictions (e.g., comparing beam prediction ML models implemented at both the network node and the UE), and determine any differences that may likely suggest a cause for the performance degradation.

As described above, network node 802 may track modifications of one or more variables to determine a cause of the performance degradation of the one or more ML models deployed to UE 804. Examples of such variables, the modification of which may cause performance degradation of the ML model(s), include one or more newly deployed nodes, carriers, etc.; one or more switching-off nodes, carriers, etc.; one or more software upgrades in one or more nodes, and/or one or more malfunctioning nodes. Further examples of such variables may include one or more of a new antenna vertical tilt or horizontal direction settings; one or more new beamforming configurations; and one or more new unique identifiers for cells or beams.

In some embodiments, network node 802 may also perform one or more operations in step 840 (e.g., collect information, track modifications of variables, analyze root cause, etc.) based on the information previously provided from other UEs in a similar manner as provided by UE 804.

With continued reference to FIG. 8, in step 850, network node 802 sends UE 804 an indication of the cause of the performance degradations of the one or more ML models. For example, if the network node 802 identifies that there have been, or they will be, modifications in any of the variables that may have an impact on the performance of the UE 804's ML model(s), network node 802 may communicate such changes to UE 804 and/or recommend a potential action to at least partially correct or prevent the performance degradations of the one or more ML models. In some embodiments, the communication of the modifications can be performed in a unicast, multicast (e.g., addressing multiple UEs that implement ML models that may be affected by changes of one or more relevant variables), or broadcast manner.

In some embodiments, if UE 804 has requested network node 802 to assist in identifying the cause of the performance degradation (described above in step 830), network node 802 may send UE 804 a representation of the cause of such performance degradation if identified, an indication that it is impossible to identify the cause, and/or a recommendation of an action related to the one or more ML models operated by the UE 804. The below examples illustrate the different types of information network node 802 may send to UE 804.

In one example, the network node 802 may send UE 804 an indication that the signal strength of a certain reference signal should be modified by x dB due to a past or future transmission power modification. In another example, network node 802 may send UE 804 an indication that a certain reference signal ID has, or will have, a new ID; and/or a certain reference signal ID is, or will be, no longer active. In another example, network node 802 may send UE 804 an indication of a change in BLER (Block Error Rate Target) or error rate target for scheduling. The signaling from network node 802 may also include specific values of the target levels.

In another example, network node 802 may send UE 804 a change in network load or specific indicators for that (e.g., the scheduling load in the serving cell and/or the neighbor cells). The indication sent from network node 802 to UE 804 can also be a measure of the number of served UEs from the network side.

In another example, network node 802 may send UE 804 an indication of a change in the number of SSB indices used or the number of wide beams used by the network. Network node 802 may for example change these parameters to reduce the power consumption during lower traffic periods.

In another example, network node 802 may send UE 804 an indication of whether UE 804 is co-scheduled with another UE on overlapping frequency and time resources. The indication may further include the relative power of the co-scheduled UEs.

In another example, network node 802 may send UE 804 an indication that there was a network malfunction; that the range of a certain feature is not reasonable; and/or that the data collected is less than the data collected for other UEs or the network for performing the same radio network operation. Network node 802 may also indicate to the UE 804 a recommended amount of data to be collected.

In another example, network node 802 may send UE 804 an indication that a feature should or is recommended not to be utilized; that a UE-reported feature importance is not similar to that of other UEs or the network node utilized for the same radio network operation (e.g., the UE and network beam prediction ML models); that a deployment/coverage modification has or will occur; and/or that no cause due to network changes is apparent.

Together with, or separated from, the above-described indications, network node 802 may also signal UE 804 the time window within which any of the above events occurred or is expected to occur.

With continued reference to FIG. 8, in an optional step 860, UE 804 may perform one or more actions based on information received from network node 802 in step 850. For example, upon reception of the information from network node 802 (e.g., modification of variables, a cause of the performance degradation, time window of the performance degradation, etc.), the UE 804 may modify one or more input features of the one or more ML models (e.g., scale a certain signal power); modifying or creating a new mapping of reference signal IDs to an output of the one or more ML models; and/or treating input features to the ML model(s) as missing values instead of utilizing a negligible value for, e.g., measurements associated to deactivated cells.

In some examples, upon reception of the information from network node 802, UE 804 may discard certain non-important feature(s) as indicated by network node 802 and retrain the one or more ML models using the modified input features. UE 804 may also collect new data and delete old data; discard data during a certain time-period when the network was malfunctioning; retrain the ML model(s) by disregarding the data from certain time-windows; retrain the ML model(s) excluding feature with an unreasonable data range; retrain the ML model(s) including feature with a recommended feature; stop using the ML model(s); and/or start performance degradation analysis at the UE 804 to, e.g., detect faulty antenna or other hardware impairments. In some embodiments, some of the actions (e.g., the retraining actions) described above may also occur in a second node as described in greater detail below.

With reference still to FIG. 8, steps 870, 880, 890 are optional. In some embodiments, upon reception of the information from network node 802 in step 850 (e.g., reception of modification of variables, a cause of the performance degradation, time window of the performance degradation, etc.), UE 804 may communicate with a second network node 806 as described below in connection with steps 870, 880, and 890. In step 870, UE 804 may communicate with a second network node 806 with the objective of sharing the information received from network node 802 (e.g., sharing the modifications of the variables, the cause of the performance degradation, etc.); indicating one or more actions performed by UE 804 upon reception of such information (e.g., input features update, model retraining, data collection etc.) and/or requesting a model-related action to be performed at second network node 806.

In one example, second network node 806 may be a server node hosting the training of the one or more ML models operable by UE 804 and/or ML models operable by other UEs. Such a server node may be hosted by, for example, the manufacturer of UE 804.

In step 880, second network node 806 may utilize the information received from UE 804 to perform one or more actions including, for example, deciding to transmit a new ML model to UE 804, retraining an ML model, initiating a data collection process, and/or performing a model error root cause analysis. The actions performed by second network node 806 may overlap with, or in addition to, actions performed by UE 804. For example, if a retraining of the ML model is a very resource consuming process that requires more computing power than UE 804 can practically provide, UE 804 may request second network node 806 to perform the retraining instead.

In step 890, second network node 806 communicates the outcome of the one or more actions performed back to UE 804. For example, second network node 806 may send UE 804 a representation of a retrained ML model; a representation of another ML model different from the current ML model used by UE 804; and an indication of an error cause analysis of the ML model.

With reference still to FIG. 8, in an optional step 895, UE 804 transmits a feedback to network node 802 associated with the received information. The feedback may simply be an acknowledgement that the information provided by network node 802 (e.g., modifications of variables, cause of performance degradations, etc.) have been received and/or acted upon by UE 804. Optionally, UE 804 may inform the network node 802 of the actions adopted in steps 860, 870, 880, and/or 890 described above.

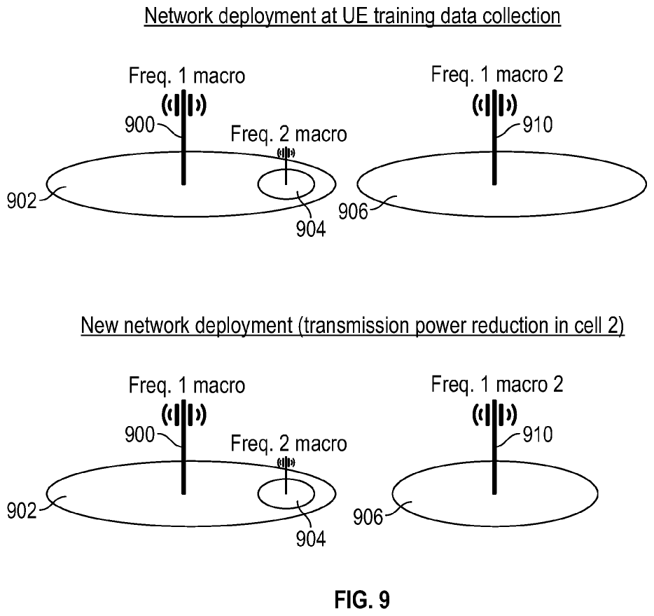

The above process described using the signal sequencing diagram shown in FIG. 8 can be exemplified with the below-described use cases provided in FIG. 9. FIG. 9 illustrates examples where a network node communicates a change in the transmission power of a neighboring cell to the UE, in accordance with some embodiments. The change in the transmission power may result in a coverage modification. Specifically, as shown in FIG. 9, network node 900 is associated with a cell 902, and network node 910 is associated with a cell 906. Cells 902 and 906, at the time of the network deployment (e.g., at the time of UE training data collection) are macro cells and have a first frequency of a frequency band. Cells 902 and 906 are neighboring cells. A cell 904 shown in FIG. 9 is a micro cell at a second frequency or the frequency band. Macro cells and micro cells are two different types of cells used in wireless communication. A macro cell usually covers a larger geographic area than a micro cell. Macro cells can support a large number of UEs simultaneously while micro cells may only support a limited number of UEs. In addition, macro cells typically provide higher data rate than micro cells. The micro cells can be used, for example, to boost capacity in the interested area and/or offload traffic from cell 902 to avoid network congestion.

As illustrated in FIG. 9, cells 902 and 906 are neighboring cells. A UE (not shown in FIG. 9) may communicate with one or both of network nodes 900 and 910 associated with cells 902 and 906 respectively. For instance, the UE may be moving between the two cells. In some scenarios, after the network deployment, the coverage of cell 906 may change over time. As shown in FIG. 9, the coverage of cell 906 may be reduced at the time of a new network deployment. The coverage reduction may be a result of a transmission power reduction by network node 910.

In one embodiment, a network (e.g., including network node 900, 910, and/or a core network) may be proactively operating to prevent ML model misbehavior or performance degradations. The UE (not shown) may report its feature information to the network in a similar way as described above in connection with step 820 shown in FIG. 8. The network can continuously monitor changes in the features in a similar way as described above in connection with step 840. If the UE utilizes a feature related to the transmission power of cell 906 (e.g., macro cell ID 2), and such transmission power changes or is planned to be changed, the network may communicate such information to the UE in a similar way as described above in connection with step 850. The UE may use such information to compensate the signal strength measurements for cell 906 when the measurements are used as an ML model input.

In another embodiments, the UE may have requested assistance from the network to identify the cause of performance degradation. For example, the UE may report its feature information to the network in a similar way as described above in connection with step 820 shown in FIG. 8. If the UE cannot predict the inter-frequency measurements accurately anymore, it may have detected a performance degradation in a similar way as described above in connection with step 810. The UE can request the network to identify the cause of the performance degradation in a similar way as described above in connection with step 830. Subsequently, the network can check for changes in the input features of the UE model in a similar way as described above in connection with step 840, and identify that the transmission power of cell 906 has changed. Further, in similar ways as described above in connection with steps 850 and 860 respectively, the network may communicate such information to the UE; and the UE may use such information to compensate the signal strength measurements for cell 906 when the measurements are used as an ML model input.

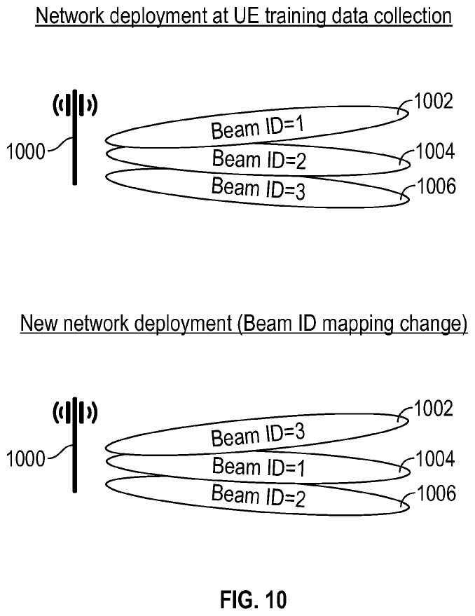

The above process described using the signal sequencing diagram shown in FIG. 8 can also be exemplified with another use cases provided in FIG. 10. FIG. 10 illustrates examples where the network deployment such as beam ID mapping changes after training of a UE's ML model, in accordance with some embodiments. As shown in FIG. 10, network node 1000 may use beamforming technologies to provide high data rate, large capacity, and better coverage. Beamforming is achieved through the use of multiple antennas on both the transmitter and receiver sides. Network node 1000 may thus be associated with multiple beams 1002, 1004, and 1006. At the time of collecting the UE's ML model training data, beams 1002, 1004, and 1006 have their corresponding beam IDs (e.g., beams IDs 1, 2, and 3). Over time, a new network deployment may have a different beam ID mapping such that beams 1002, 1004, and 1006 may have different beam IDs (e.g., beam IDs 3, 1, and 2). The different beams may have different directions for specific UEs or locations.

In one embodiment, a network (e.g., including network node 1000, other network nodes, and/or a core network) may communicate with a UE (not shown) and may be proactively operating to prevent ML model misbehavior or performance degradations. The UE reports its feature information to the network in a similar way as described above in connection with step 820 shown in FIG. 8. The network can continuously monitor changes in the features. If the UE utilizes a feature related to the CSI-RS ID, and such CSI-RS-ID changes or is planned to be changed, the network may communicate such information to the UE. The UE may use such information to translate the beam-IDs to the new values. A CSI-RS ID is a unique identifier used to distinguish between different CSI-RS configurations and enable the receiver to properly decode and interpret the CSI-RS information.

In another embodiment, the UE may have requested assistance from the network (e.g., network node 1000) to identify the cause of performance degradation. For example, the UE may report its feature information to the network in a similar way as described above in connection with step 820 shown in FIG. 8. If the UE cannot accurately predict beams anymore, it may have detected a performance degradation in a similar way as described above in connection with step 810. The performance degradation may be due to, e.g., a CSI-RS-ID change in a network node, i.e., the IDs related to how the network node maps the antennas onto the beams for a certain reference signal have changed. Hence, the UE cannot directly use the learning from previous ML model training. After the UE sends the network the feature information including the beam IDs, the network detects that the UE uses old CSI-RS ID values and responds with the translation of beam-IDs to the new values. The communication from the network to the UE can be performed in a similar way as described above in connection with steps 850. Upon receiving the new values, the UE can perform one or more actions in a similar manner as described above in connection with step 860 to prevent or at least partially correct the performance degradations caused by the CSI-RS-ID changes.

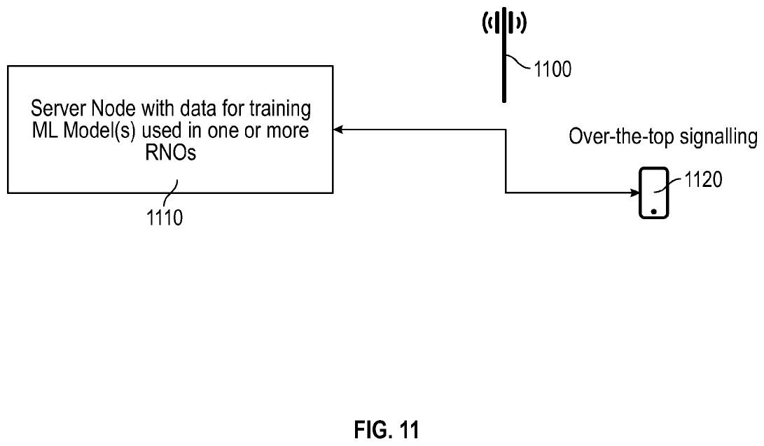

FIG. 11 illustrates an exemplary over-the-top signaling between a server node 1110 and a UE 1120 for training an ML-model, in accordance with some embodiments. Over the top signaling, also known as OTT signaling, refers to the communication protocol used by applications and services that run on top of an existing network infrastructure. Thus, while the above descriptions in FIGS. 8-11 use communications between network nodes and UEs as examples, such communications can be performed via OTT signaling. One example is shown in FIG. 11, where a server node 1110 (e.g., corresponding to the second network node 806 in FIG. 8) can communicate with UE 1120 via an OTT connection through network node 1110. The OTT connection may enable the training and retraining of the one or more ML models deployed to UE 1120 by the server node 1110. These ML models can be used for multiple radio network operations.

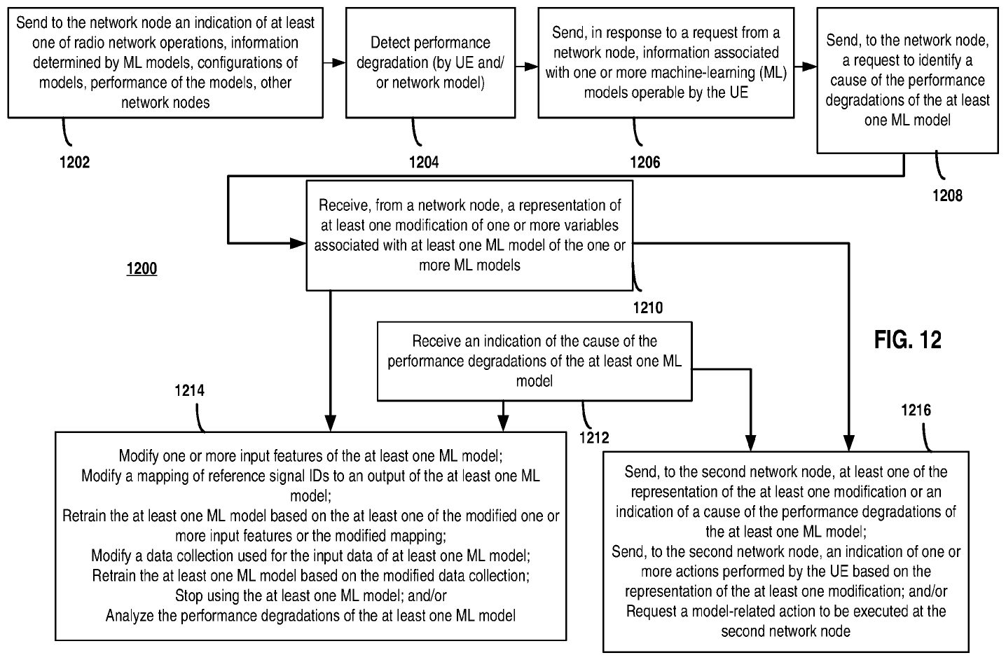

FIG. 12 is a flowchart illustrating a method 1200 performed by a UE in accordance with some embodiments. In step 1200, the UE sends the network node an indication of at least one of: one or more radio network operations executable by the UE based on the one or more ML models; information determined by the one or more ML models; information associated with configurations of the one or more ML models; information associated with performance of the one or more ML models; and identification of one or more other network nodes related to the one or more ML models. Step 1200 corresponds to step 800 described above. Next, in step 1204, the UE detects the performance degradation of the one or more ML models. This is an optional step and can also be performed by the network node. In some examples, when the performance degradation is detected by the network node, the UE receives, from the network node, one or more modifications related to the performance degradation. The detection of the performance degradation is based on at least one of: one or more outputs predicted by the at least one ML model; actual measurements of one or more parameters associated with performance monitoring of the at least one ML model; historical data associated with the performance of the at least one ML model; and data associated with performance of a corresponding ML model of one or more other UEs. Step 1204 corresponds to step 810 described above.

In step 1206, the UE sends, in response to a request from the network node, information associated with one or more machine-learning (ML) models operable by the UE. For example, the UE can send feature information used by the one or more ML models; information related to data collection by the UE; and model-related information of the one or more ML models. Step 1206 corresponds to step 820 described above.

In an optional step 1208, the UE sends, to the network node, a request to assist the UE identifying a cause of the performance degradations of the at least one ML model. Step 1208 corresponds to step 830 described above.

In step 1210, the UE receives, from the network node, a representation of at least one modification of one or more variables associated with at least one ML model of the one or more ML models. The one or more variables are based on the information associated with the one or more ML models sent from the UE to the network node. The at least one modification of the one or more variables facilitates at least partially correcting or preventing performance degradations of the at least one ML model. In step 1212, the UE receives, from the network node, an indication of the cause of the performance degradations of the at least one ML model. One or both steps 1210 and step 1212 may occur. Steps 1210 and 1212 correspond to step 850 described above.

In step 1214, the UE, based on the received representation of the at least one modification, performs at least one of: modifying one or more input features of the at least one ML model; modifying a mapping of reference signal IDs to an output of the at least one ML model; and retaining the at least one ML model based on the at least one of the modified one or more input features or the modified mapping. In some examples, the UE may also, based on the received representation of the at least one modification, perform at least one of: modifying a data collection used for the input data of at least one ML model; and retraining the at least one ML model based on the modified data collection. In some examples, the UE may perform at least one of stopping using the at least one ML model; and analyzing the performance degradations of the at least one ML model. Step 1214 corresponds to step 860 described above.

In step 1216, alternatively or additionally, the UE communicates with a second network node to perform one or more of: sending, to the second network node, at least one of the representation of the at least one modification or an indication of a cause of the performance degradations of the at least one ML model; sending, to the second network node, an indication of one or more actions performed by the UE based on the representation of the at least one modification; and requesting a model-related action to be executed at the second network node. Step 1216 corresponds to step 870 described above.

In another step (not shown in FIG. 12), the UE receives, from the second network node, one or more of: a representation of a retrained at least one ML model; a representation of another ML model different from the at least one ML model; and an indication of an error cause analysis of the at least one ML model. This step corresponds to step 890 described above.

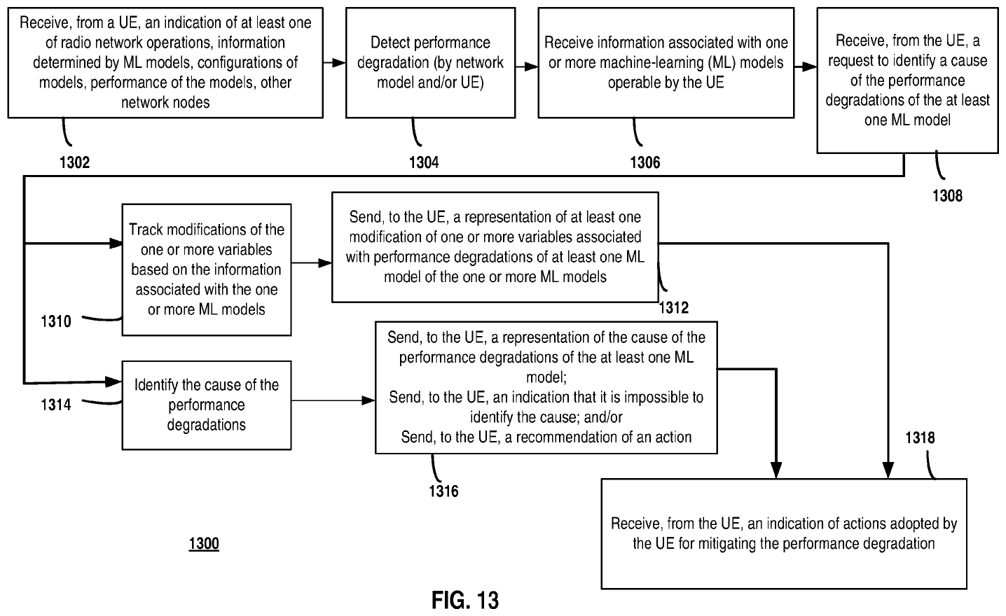

FIG. 13 is a flowchart illustrating a method 1300 performed by a network node in accordance with some embodiments. In step 1302, the network node receives, from the UE, an indication of at least one of one or more radio network operations executable by the UE based on the one or more ML models; information determined by the one or more ML models; information associated with configurations of the one or more ML models; information associated with performance of the one or more ML models; and an identification of one or more other network nodes related to the one or more ML models. Step 1302 corresponds to step 800 described above.

In step 1304, the network node detects the performance degradation of at least one ML model of the one or more ML models. In some examples, this detection is performed by the UE. When the performance degradation is detected by the network node, the network node can send the UE one or more modifications related to the performance degradations (see step 1312). The detection of the performance degradation is based on at least one of: one or more outputs predicted by the at least one ML model; actual measurements of one or more parameters associated with performance monitoring of the at least one ML model; historical data associated with the performance of the at least one ML model; and data associated with performance of a corresponding ML model of one or more other UEs. Step 1304 corresponds to step 810 described above.

In step 1306, the network node receives, from the UE, the information associated with the one or more ML models operable by the UE. The information associated with the one or more ML models operable by the UE comprises at least one of: feature information used by the one or more ML models; information related to data collection by the UE; and model-related information of the one or more ML models. In some examples, this step is preceded by a step in which the network node requests a user equipment (UE) to report information associated with one or more machine-learning (ML) models operable by the UE. Step 1306 corresponds to step 820 described above.

In step 1308, the network node receives a request from the UE to assist the UE identifying a cause of the performance degradations of the at least one ML model. This step 1308 corresponds to step 830 described above.

In step 1310, the network node tracks modifications of the one or more variables based on the information associated with the one or more ML models, wherein the tracked modifications facilitate at least partially correcting or preventing the performance degradations. The one or more variables include a newly-deployed node and a newly-deployed carrier; one or more of a switching off node and a switching-off carrier; one or more software upgrades in one or more nodes; and/or one or more malfunctioning nodes. The one or more variables may also include one or more of a new antenna vertical tilt or horizontal direction settings; one or more new beamforming configurations; and one or more new unique identifiers for cells or beams.

In step 1312, the network node sends, to the UE, a representation of at least one modification of one or more variables associated with at least one ML model of the one or more ML models. The one or more variables are based on the information associated with the one or more ML models, and the at least one modification of the one or more variables facilitates at least partially correcting or preventing the performance degradations of the at least one ML model. Steps 1310 and 1312 correspond to steps 840 and 850 described above.

In step 1314, the network node identifies a cause of the performance degradations of the at least one ML model. The identification of the cause of the performance degradations is based on at least one of: determining whether the one or more variables have modifications within a time window; utilizing at least one of the information associated with the at least one ML model operable by the UE or information associated with a corresponding ML model operable by one or more other UEs; and comparing information associated with the at least one ML model with information associated with a corresponding ML model operable by the network node. Step 1314 corresponds to step 840 described above.

In step 1316, the network node sends the UE an indication of the cause of the performance degradations of the at least one ML model, an indication that it is impossible to identify the cause; and a recommendation of an action related to the at least one ML model operable by the UE. Step 1316 corresponds to step 850 described above.

In step 1318, the network node receives, from the UE, an indication of actions adopted by the UE for mitigating the performance degradation. This step corresponds to step 895 described above.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method performed by a user equipment for performing user equipment (UE) machine-learning (ML) model analysis, the method comprising:
transmitting, in response to a request from a network node, information associated with performance degradation of a ML model used in the UE; and
receiving a representation of at least one modification of one or more variable associated with the performance degradation of the ML model, wherein:
the one or more variables associated with the performance degradations of the ML model are based on the information, and
   the at least one modification of the one or more variables is used to at least partially correct the performance degradations.

2. The method of embodiment 1, further comprising the step of transmitting an indication of radio network operations using the ML model, wherein the indication comprises one or more of:
reports associated with radio resource management;
reports associated with UE measurement;
reports associated with mobility operations;
reports associated with random access operations;
reports associated with dual or multi-connectivity operation;
reports associated with beamforming operations;
reports associated with radio resource control (RRC) state handling;
reports associated with traffic control;
reports associated with energy efficiency operations; and
information determined based on the ML model.

3. The method of embodiment 1, further comprising the step of:
detecting the performance degradation of the ML model used in the UE.

4. The method of embodiment 1, wherein the information associated with the performance degradation of the ML model comprises:
feature information;
data collection information; and
information related to the ML model.

5. The method of embodiment 1, further comprising the step of:
requesting network assistance to identify a cause of the performance degradation of the ML model.

6. The method of embodiment 1, further comprising the step of upon receiving the representation of the at least one modification, performing one or more actions of:
modifying a feature;
creating a new mapping of reference signal IDs to the ML model output;
considering input features as missing values;
retraining the ML model based on discarding non-important feature/s as indicated by the network node;
collecting new data and delete old data;
discarding data during a certain time-period when the network was malfunctioning;
retraining the ML model based on disregarding the data from certain time-windows;
retraining the ML model excluding feature with an unreasonable data range;
retraining the ML model including a recommended feature;
stopping using the model; and
starting performance degradation analysis at the UE.

7. The method of embodiment 1, further comprising the step of communicating with a second network node to perform one or more of:
sharing the information received from the network node;
indicating one or more actions performed based on the representation of the at least one modification; and
requesting a model-related action to be executed at the second network node.

8. The method of embodiment 7, wherein the second node is configurated to perform:
determining to transmit a new ML model to the UE;
retraining an ML model;
initiating a data collection process; and
performing a model error cause analysis.

9. The method of any of the previous embodiments, further comprising:
providing user data; and
forwarding the user data to a host via the transmission to the network node.

### Group B Embodiments

10. A method performed by a network node for performing user equipment (UE) machine-learning (ML) model analysis, the method comprising:
requesting a UE to report ML model based operations the UE is capable of executing;
receiving information associated with the ML model based operations;
determining, based on the information associated with the ML model based operations, one or more variables associated with performance degradations of at least one ML model of the UE;
identifying at least one modification of the one or more variables for at least partially correcting the performance degradations; and
transmitting a representation of the at least one modification of the one or more variable to the UE.

11. The method of embodiment 10, further comprising the step of:
tracking modifications of the one or more variables that have impact on performance of the UE's ML mode.

12. The method of embodiment 10, further comprising the step of:
receiving a request from the UE to assist identifying a cause of the performance degradation; and
identifying the cause of the performance degradation based on the request.

13. The method of embodiment 12, wherein identifying the cause of the performance degradation comprises one or more of:
determining whether the one or more variables have modifications within a time window;
utilizing the information associated with the UE's ML model based operations; and
comparing information associated with the UE's ML model with a network specific model capable of performing operations that are the same as the UE's ML model based operations.

14. The method of embodiment 10, wherein the one or more variable comprises one or more of:
one or more newly deployed nodes and/or carriers;
one or more switching off nodes and/or carriers;
one or more software upgrades in one or more nodes;
one or more new antenna vertical tilt, or horizontal direction settings;
one or more new beamforming configurations;
one or more new unique identifiers for cells or beams; and
one or more malfunctioning nodes.

15. The method of embodiment 10, wherein transmitting the representation of the at least one modification is performed using unicast or multicast.

16. The method of embodiment 10, further comprising the step of: in response to a request from the UE to assist identifying a cause of the performance degradation, performing one or more of:
communicating the cause of the performance degradation;
communicating an impossibility to identify the cause; and
communicating a recommendation of an action related to the UE's ML model.

17. The method of embodiment 10, wherein the at least one modification relates to one or more of:
a signal strength of a reference signal;
a reference signal ID;
an active status of the reference signal ID;
block error rate target;
network load;
a number of synchronization signal block (SSB) indices used or a number of wide beams used by the network;
whether the UE is co-scheduled with another UE on overlapping frequency and time resources;
a network malfunction;
an unreasonable range of a feature;
a reasonable value of a feature that could not be retrieved for the UE;
a data collection less than a data collection for other UEs;
an unrecommended feature;
a difference between a UE-reported feature and a same feature of other UEs; and
a deployment and/or coverage modification.

18. The method of any of the previous embodiments, further comprising:
obtaining user data; and
forwarding the user data to a host or a user equipment.

### Group C Embodiments

19. A user equipment for performing user equipment (UE) machine-learning (ML) model analysis, comprising:
processing circuitry configured to perform any of the steps of any of the Group A embodiments; and
power supply circuitry configured to supply power to the processing circuitry.

20. A network node for performing user equipment (UE) machine-learning (ML) model analysis, the network node comprising:
processing circuitry configured to perform any of the steps of any of the Group B embodiments;
power supply circuitry configured to supply power to the processing circuitry.

21. A user equipment (UE) for performing user equipment (UE) machine-learning (ML) model analysis, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

22. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

23. The host of the previous embodiment, wherein the cellular network further includes a network node configured to communicate with the UE to transmit the user data to the UE from the host.

24. The host of the previous 2 embodiments, wherein:
the processing circuitry of the host is configured to execute a host application, thereby providing the user data; and
the host application is configured to interact with a client application executing on the UE, the client application being associated with the host application.

25. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

26. The method of the previous embodiment, further comprising:
at the host, executing a host application associated with a client application executing on the UE to receive the user data from the UE.

27. The method of the previous embodiment, further comprising:
at the host, transmitting input data to the client application executing on the UE, the input data being provided by executing the host application,
wherein the user data is provided by the client application in response to the input data from the host application.

28. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

29. The host of the previous embodiment, wherein the cellular network further includes a network node configured to communicate with the UE to transmit the user data from the UE to the host.

30. The host of the previous 2 embodiments, wherein:
the processing circuitry of the host is configured to execute a host application, thereby providing the user data; and
the host application is configured to interact with a client application executing on the UE, the client application being associated with the host application.

31. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

32. The method of the previous embodiment, further comprising:
at the host, executing a host application associated with a client application executing on the UE to receive the user data from the UE.

33. The method of the previous embodiment, further comprising:
at the host, transmitting input data to the client application executing on the UE, the input data being provided by executing the host application,
wherein the user data is provided by the client application in response to the input data from the host application.

34. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

35. The host of the previous embodiment, wherein:
the processing circuitry of the host is configured to execute a host application that provides the user data; and
the UE comprises processing circuitry configured to execute a client application associated with the host application to receive the transmission of user data from the host.

36. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

37. The method of the previous embodiment, further comprising, at the network node, transmitting the user data provided by the host for the UE.

38. The method of any of the previous 2 embodiments, wherein the user data is provided at the host by executing a host application that interacts with a client application executing on the UE, the client application being associated with the host application.

39. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

40. The communication system of the previous embodiment, further comprising:
the network node; and/or
the user equipment.

41. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

42. The host of the previous 2 embodiments, wherein:
the processing circuitry of the host is configured to execute a host application, thereby providing the user data; and
the host application is configured to interact with a client application executing on the UE, the client application being associated with the host application.

43. The host of the any of the previous 2 embodiments, wherein the initiating receipt of the user data comprises requesting the user data.

44. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

45. The method of the previous embodiment, further comprising at the network node, transmitting the received user data to the host.

The foregoing specification is to be understood as being in every respect illustrative and exemplary, but not restrictive, and the scope of the disclosure herein is not to be determined from the specification, but rather from the claims as interpreted according to the full breadth permitted by the patent laws. It is to be understood that the embodiments shown and described herein are only illustrative of the principles of the present disclosure and that various modifications may be implemented by those skilled in the art without departing from the scope and spirit of the present disclosure. Those skilled in the art could implement various other feature combinations without departing from the scope and spirit of the disclosure.

1. A method performed by a user equipment (UE), the method comprising:
sending, in response to a request from a network node, information associated with one or more machine-learning (ML) models operable by the UE; and
receiving, from a network node, a representation of at least one modification of one or more variables associated with at least one ML model of the one or more ML models, wherein:
the one or more variables are based on the information associated with the one or more ML models, and
the at least one modification of the one or more variables facilitates at least partially correcting or preventing performance degradations of the at least one ML model.

2. The method of claim 1, further comprising sending the network node an indication of at least one of:
one or more radio network operations executable by the UE based on the one or more ML models;
information determined by the one or more ML models;
information associated with configurations of the one or more ML models;
information associated with performance of the one or more ML models; and
identification of one or more other network nodes related to the one or more ML models.

3. The method of claim 1, wherein the performance degradation of the at least one ML model of the one or more ML models is detected by at least one of the UE or the network node, and wherein when the performance degradation is detected by the network node, receiving the representation of the at least one modification comprises receiving, from the network node, one or more modifications related to the performance degradations.

4. The method of claim 3, wherein the detection of the performance degradation is based on at least one of:
one or more outputs predicted by the at least one ML model;
actual measurements of one or more parameters associated with performance monitoring of the at least one ML model;
historical data associated with the performance of the at least one ML model; and
data associated with performance of a corresponding ML model of one or more other UEs.

5. The method of claim 1, wherein sending the information associated with the one or more ML models comprises sending at least one of:
feature information used by the one or more ML models;
information related to data collection by the UE; and
model-related information of the one or more ML models.

6. The method of claim 1, further comprising:
sending, to the network node, a request to assist the UE identifying a cause of the performance degradations of the at least one ML model; and
receiving an indication of the cause of the performance degradations of the at least one ML model.

7. The method of claim 1, further comprising:
sending, to the network node, a request to assist the UE preventing the performance degradations of the at least one ML model.

8. The method of claim 1, further comprising: based on the received representation of the at least one modification, performing at least one of:
modifying one or more input features of the at least one ML model;
modifying a mapping of reference signal IDs to an output of the at least one ML model; and
retaining the at least one ML model based on the at least one of the modified one or more input features or the modified mapping.

9. The method of claim 1, further comprising: based on the received representation of the at least one modification, performing at least one of:
modifying a data collection used for the input data of at least one ML model; and
retraining the at least one ML model based on the modified data collection.

10. The method of any of claims claim 1, further comprising performing at least one of:
stopping using the at least one ML model; and
analyzing the performance degradations of the at least one ML model.

11. The method of claim 1, further comprising: communicating with a second network node to perform one or more of:
sending, to the second network node, at least one of the representation of the at least one modification or an indication of a cause of the performance degradations of the at least one ML model;
sending, to the second network node, an indication of one or more actions performed by the UE based on the representation of the at least one modification; and
requesting a model-related action to be executed at the second network node.

12. The method of claim 11, further comprising, receiving, from the second network node, one or more of:
a representation of a retrained at least one ML model;
a representation of another ML model different from the at least one ML model; and
an indication of an error cause analysis of the at least one ML model.

13. A method performed by a network node, the method comprising:
requesting a user equipment (UE) to report information associated with one or more machine-learning (ML) models operable by the UE;
receiving, from the UE, the information associated with the one or more ML models operable by the UE;
sending, to the UE, a representation of at least one modification of one or more variables associated with at least one ML model of the one or more ML models, wherein:
the one or more variables are based on the information associated with the one or more ML models, and
the at least one modification of the one or more variables facilitates at least partially correcting or preventing the performance degradations of the at least one ML model.

14. The method of claim 13, further comprising: receiving, from the UE, an indication of at least one of:
one or more radio network operations executable by the UE based on the one or more ML models;
information determined by the one or more ML models;
information associated with configurations of the one or more ML models;
information associated with performance of the one or more ML models; and
an identification of one or more other network nodes related to the one or more ML models.

15. The method of claim 13 wherein the performance degradation of at least one ML model of the one or more ML models is detected by at least one of the UE or the network node, and wherein when the performance degradation is detected by the network node, sending the representation of the at least one modification comprises sending, to the UE, one or more modifications related to the performance degradations.

16. (canceled)

17. The method of claim 13, wherein receiving, from the UE, the information associated with the one or more ML models operable by the UE comprises receiving at least one of:
feature information used by the one or more ML models;
information related to data collection by the UE; and
model-related information of the one or more ML models.

18. The method of any of claims claim 13, further comprising: tracking modifications of the one or more variables based on the information associated with the one or more ML models, wherein the tracked modifications facilitate at least partially correcting or preventing the performance degradations.

19. The method of any of claim 13, further comprising:
receiving a request from the UE to assist the UE identifying a cause of the performance degradations of the at least one ML model; and
sending to the UE an indication of the cause of the performance degradations of the at least one ML model.

20. The method of claim 19, wherein identifying the cause of the performance degradations is based on at least one of:
determining whether the one or more variables have modifications within a time window;
utilizing at least one of the information associated with the at least one ML model operable by the UE or information associated with a corresponding ML model operable by one or more other UEs; and
comparing information associated with the at least one ML model with information associated with a corresponding ML model operable by the network node.

21. The method of claim 19, further comprising: in response to the request from the UE to assist identifying the cause of the performance degradations, sending to the UE one or more of:
a representation of the cause of the performance degradations;
an indication that it is impossible to identify the cause; and
a recommendation of an action related to the at least one ML model operable by the UE.

22. The method of claim 13, further comprising: receiving, from the UE, a request to assist the UE preventing the performance degradations of the at least one ML model.

23-27. (canceled)

28. A network node for performing user equipment (UE) machine-learning (ML) model analysis, the network node comprising:
a transceiver, a processor, and a memory, said memory containing instructions executable by the processor whereby the network node is operative to perform:
requesting a user equipment (UE) to report information associated with one or more machine-learning (ML) models operable by the UE;
receiving, from the UE, the information associated with the one or more ML models operable by the UE;
sending, to the UE, a representation of at least one modification of one or more variables associated with at least one ML model of the one or more ML models, wherein:
the one or more variables are based on the information associated with the one or more ML models, and
the at least one modification of the one or more variables facilitates at least partially correcting or preventing the performance degradations of the at least one ML model.

29-42. (canceled)

43. A user equipment (UE) comprising:
a transceiver, a processor, and a memory, said memory containing instructions executable by the processor whereby the UE is operative to perform:
sending, in response to a request from a network node, information associated with one or more machine-learning (ML) models operable by the UE; and
receiving, from a network node, a representation of at least one modification of one or more variables associated with at least one ML model of the one or more ML models, wherein:
the one or more variables are based on the information associated with the one or more ML models, and
the at least one modification of the one or more variables facilitates at least partially correcting or preventing performance degradations of the at least one ML model.

44-54. (canceled)
